(19) United States
(12) Patent Application Publication
(10) Pub. No.: US 2005/0154906 A1
(43) Pub. Date: Jul. 14, 2005

(54) BIOS locked application media

(76) Inventors: Patrick Kriech, Vermillion, SD (US); Akhil Rodrigues, South Bend, IN (US); Steven Groetken, Sioux City, IA (US)

Correspondence Address: GATEWAY, INC.;ATTN: SCOTT CHARLES RICHARDSON, 610 GATEWAY DRIVE, MAIL DROP Y-04, N. SIOUX CITY, SD, 57049, US

(21) Appl. No.: 10/981,122

(22) Filed: Nov. 4, 2004

Related U.S. Application Data
(60) Provisional application No. 60/517,189, filed on Nov. 5, 2003.

(51) Int. Cl. H04L 9/32

(52) U.S. Cl. 713/193

(57) ABSTRACT

The present invention is directed to a system for protecting content, perhaps an application, from being installed on a system on which it is not intended for installation, or perhaps is not licensed. The content may be protected by an installation wrapper that requires a password before installation or unlocking. A setup program may be provided which searches persistent memory for one or more key data points at one or more locations, and if found, provides the password to the installation wrapper for proper installation of the content.

### FIELD OF THE INVENTION

This application is related to, and claims priority to U.S. provisional application No. 60/517,189, filed Nov. 4, 2003, entitled “BIOS LOCKED APPLICATION MEDIA”, Attorney Docket Number P1987US00, the entirety of which is incorporated by reference herein, including all of the documents referenced therein.

The present invention generally relates to the field of protecting content from unauthorized use, perhaps protecting software from being installed in a computer in which it is not licensed.

### BACKGROUND OF THE INVENTION

Manufacturers of systems often provide backup materials so that user can restore the system to the state it was in when the system was delivered. Often, this backup material consists of media containing valuable content, perhaps software such as Microsoft Office Suite®, Microsoft Windows XP®, etc. It would be valuable to protect this software from being installed on systems with similar capabilities from different manufacturers. For example, if a system is purchase from vendor G and the system comes with an operating system recovery CDROM, the operating system supplier would not want the user to be able to install the operating system on a system purchased from vendor H. Being that most systems supplied from vendor G are shipped with this operating system pre-installed, it might be acceptable for the user to utilize this recovery disk to install the operating system on a different system from vendor G.

Previously, this protection may have been accomplished by modifying the installation software for the content (e.g., the application) to know about key data points within the vendor specific system, and only allow installation when those key data points are detected. For example, the Microsoft installation program for Office 2003® could be modified to search certain locations in memory for the word “Gateway” and, if found, continue installation or if not found, display an error and exit. This method is difficult to implement, in that the software provider (e.g., Microsoft) would be required to know where the key data points are located and integrate this knowledge into its installation software (e.g., setup.exe). The software provider would have to track any changes to these key data points and it would have to be aware of any new systems that are released by the system supplier that have different data points. This creates a level of complexity between the software provider and the system supplier that is undesired.

Therefore, it would be desirable to provide a system and method for protecting the content from installation on unintended systems, e.g., systems from different vendors.

### SUMMARY OF THE INVENTION

Accordingly, the present invention is directed to a system and method for protecting content from being installed on unauthorized systems. The content can be many things such as music, video, software, applications, tools, sounds, etc.

In one aspect of the present invention, the system has key data points embedded in persistent memory. The content may be protected by an installation wrapper that requires a password before installation is allowed. The recovery disk or installation media may be provided with an auto-run program such as a file named autorun.inf which is recognized by some operating systems as a file containing initialization directives that are executed when it is inserted into a reader, perhaps a CDROM drive or a DVD drive. The auto-run file may contain directives to initiate a set-up program, perhaps an executable such as setup.exe. Optionally, there may not be an auto-run program and the user would have to initiate the setup program. The setup program may search for various key data points to verify that the content is authorized to be installed on the system. For example, the key data points may be specific values or strings found in persistent memory, values in certain registers or values stored in DMI (Desktop Management Interface) tables. In one embodiment, the key data points may be the string “Gateway” found in specific locations within the BIOS ROM. If the setup program finds the key data points, then it initiates the install program using the same password that was used to create the installation wrapper. In this case, the installation wrapper continues to install the content. If the setup program doesn't find the key data points, then the content is not installed and an error message may be displayed for the user.

In another aspect of the present invention, the system has key data points embedded in persistent memory. The content may be protected by encrypting it with a password or key. The recovery disk or installation media may be provided with an auto-run program such as a file named autorun.inf which is recognized by some operating systems as a file containing initialization directives that are executed when it is inserted into a reader, perhaps a CDROM drive or a DVD drive. The auto-run file may contain directives to initiate a set-up program, perhaps an executable such as setup.exe. Optionally, there may not be an auto-run program and the user would have to initiate the setup program. The setup program may search for various key data points to verify that the content is authorized to be installed on the system as in the previous embodiment. If the setup program finds the key data points, then it decrypts the content using the same password that was used to encrypt the content. The setup program may then continue to install the content by executing an installation program provided with the content, perhaps a set-up program called setup.exe provided with the content if the content is an application. If the setup program doesn't find the key data points, then the content is not installed and an error message may be displayed for the user.

It is to be understood that both the foregoing general description and the following detailed description are exemplary and explanatory only and are not restrictive of the invention as claimed. The accompanying drawings, which are incorporated in and constitute a part of the specification, illustrate an embodiment of the invention and together with the general description serve to explain the principles of the invention.

### BRIEF DESCRIPTION OF THE DRAWINGS

The numerous advantages of the present invention may be better understood by those skilled in the art by reference to the accompanying figures in which:

FIG. 1 is a system block diagram of the present invention.

FIG. 2 is a flow chart of the present invention.

FIG. 3 is a flow chart of the present invention showing how an application may be installed.

FIG. 4 is a flow chart of the present invention using encryption to protect the content.

### DETAILED DESCRIPTION OF THE INVENTION

Reference will now be made in detail to the presently preferred embodiments of the invention, examples of which are illustrated in the accompanying drawings.

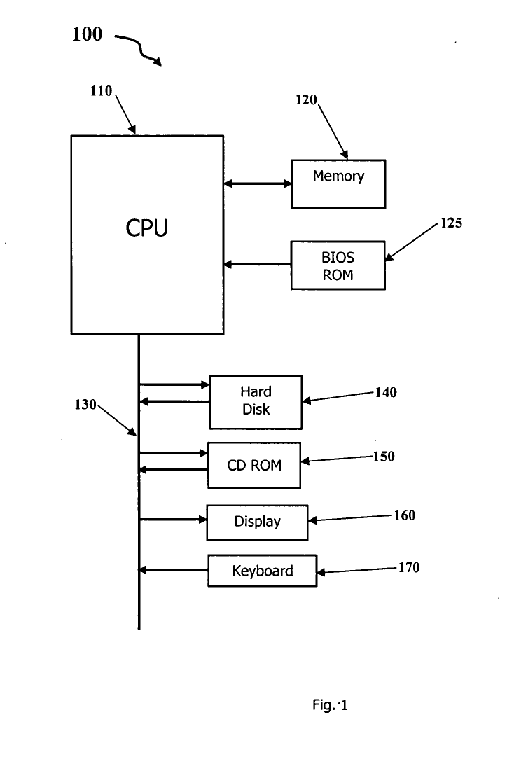

Referring generally now to FIG. 1, an exemplary embodiment of a computer system suitable for the implementation of the present invention is shown.

Referring to FIG. 1, a system block diagram of a computer system of the present invention. In this, a processor 110 is provided to execute stored programs which are generally stored within memory 120. Processor 110 can be any processor, perhaps an Intel Pentium-4® CPU or the like. Memory 120, connected to the processor, can be any memory suitable for connection with the selected processor 110, such as SRAM, DRAM, SDRAM, RDRAM, DDR, DDR-2, etc. BIOS ROM 125 is possibly a read-only memory that is connected to processor 110 and may contain initialization software, sometimes known as BIOS. This initialization software usually operates when power is applied to the system or when the system is reset. Sometimes, the software is read and executed directly from BIOS ROM 125. Alternately, the initialization software may be copied into memory 120 and executed from there to improve performance. Also connected to CPU 110 is bus 130 for connecting peripheral subsystems such as a hard disk 140, CDROM 150, display 160 and keyboard 170. In general, the hard disk 140 may be used to store programs, executable code and data persistently, while the CDROM 150 may be used to load said programs, executable code and data from removable media onto the hard disk 140. Although there are many other uses for these devices, this invention relates to the installation of programs, executable code and data from CDROM 150 onto a hard disk 140. These peripherals are meant to be examples of persistent storage and removable media storage. Other examples of persistent storage include core memory, FRAM, flash memory, etc. Other examples of removable media storage include CDRW, DVD, DVD writeable, compact flash, other removable flash media, floppy disk, ZIP®, laser disk, etc. Although FIG. 1 shows an exemplary computing system; the present invention is not limited to any particular computer system architecture. BIOS ROM is a term for persistent memory in which an initialization program is stored. This memory required so the software and information contained within the memory is available whenever power is turned on or the system is reset. BIOS stands for Basic Input Output System, but newer pre-execution environments are starting to enter the market and the name may vary without changing the applicability to the present invention. Persistent memory can be any form of memory that retains its values after the system is shut down, perhaps ROM, PROM, EPROM, EEPROM, Flash, one-time programmable memory, battery-backed SRAM and FRAM. It may be used to store initialization software, such as BIOS, or for other purposes. For example, it might be the battery backed SRAM that is used to store initialization parameters.

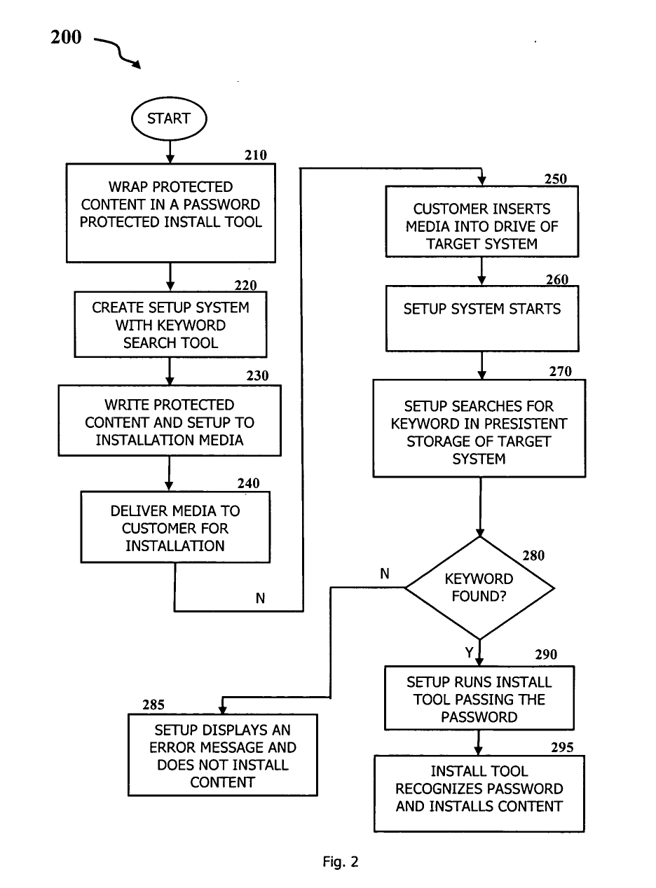

Referring to FIG. 2, a flow chart of the present invention, step 210 includes wrapping the content in a password protected installation tool. In step 220, a setup system is created, perhaps a program called setup.exe which may be a 32 bit BIOS reading program written, perhaps, with Borland's Delphi 6. The setup system may be invoked by an auto-run initialization script, such as autorun.inf, that executes when the media is inserted into drive 150. The setup system has software that searches the system for key data points. The key data points may be a word or string such as “Gateway” stored at or more predetermined locations in persistent memory, preferably somewhere in the initialization ROM. The initialization ROM may be any form of persistent memory such as EPROM, EEPROM, FLASH, FRAM, etc. and usually holds initialization software such as BIOS. In another embodiment, there may be multiple key data points, whereas finding at least one key data point may be sufficient to identify a valid system. In other embodiments there may be multiple key data points and more than one may be required to identify a valid system. For example, the word “copyright” may be required to be at a first location and the word “Gateway” at a second location before the setup system permits installation. In another embodiment, one or more of the key data points may be located in what is known as, CMOS RAM, or the battery backed SRAM that is found in many computer systems for storing setup information. It is best if the key data points are stored in a memory that is persistent, in that it will be present even after power has been lost, and a memory that is difficult to modify. It is difficult to modify a ROM, or an erasable/reprogrammable ROM such as Flash when it is part of the initialization base of a system. Even though there are programs, often supplied by the manufacture of the system, that will reprogram the BIOS ROM, these program generally require a valid BIOS image from the supplier. Any partial modification of BIOS may render the system inoperable.

Continuing with step 230 of FIG. 2, the protected content and setup program are written to an installation media. This media may be any type of media that can be used to load programs. For example, it may be an optical (e.g., CDROM/CDRW/DVD) disk, floppy disk, removable flash device, ROM device, ZIP disk, etc. The media is then delivered to the customer for use, perhaps, if their system becomes corrupt or if they need to replace their primary hard disk. The media may be delivered with the system, mailed to the customer, or, in another embodiment, the customer may access the information through the internet, possibly from a different system, and create the installation media. The media may contain other files that may or may not be used or installed, such as an autoload.inf file. Some of these files may not be protected while others may be protected. The media may also be bootable.

When the customer needs to load the content from the media, the customer inserts it into the drive of the target system 250. If an autorun file such as autorun.inf is present on the media, the operating system may automatically start the setup system 260, possibly setup.exe. Alternately, the user may be required to start the setup system 260 manually. Once started, setup searches for the key data points in persistent storage 270. For example, setup may search for the keyword, “Gateway” at a few different locations in the BIOS ROM. At step 280, it is determined if a key data point has been found. If a key data point has not been found, step 285 displays an error message and the content is not unlocked and is not loaded. If a key data point is found, step 290 runs the install tool with the required password. At step 295 the install tool recognizes the correct password, unlocks the content and installs the content on the target system.

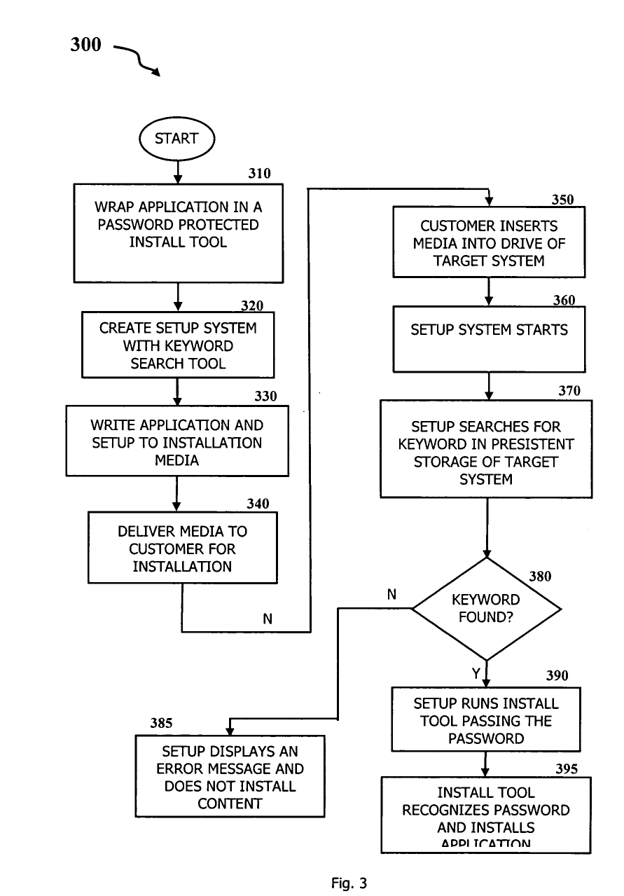

Referring to FIG. 3, a flow chart of the present invention for installing applications, step 310 includes wrapping the application in a password protected installation tool. The application may be a set of programs such as Microsoft Office®. In step 320, a setup system is created, perhaps a program called setup.exe which may be a 32 bit BIOS reading program written, perhaps, with Borland's Delphi 6. the setup system may be invoked by an auto-run initialization script, such as autorun.inf, that executes when the media is inserted into drive 150. The setup system has software that searches the system for key data points. The key data points may be a word or string such as “Gateway” stored somewhere in persistent memory, preferably somewhere in the initialization ROM. The initialization ROM may be any form of persistent memory such as EPROM, EEPROM, FLASH, FRAM, etc. and usually holds initialization software such as BIOS. In some embodiment, there may be multiple key data points, whereas finding at least one key data point may be sufficient to identify a valid system. In other embodiments there may be multiple key data points and more than one may be required to identify a valid system. For example, the word “copyright” may be required to be at a first location and the word “Gateway” at a second location before the setup system permits installation. In another embodiment, one or more of the key data points may be located in what is known as, CMOS RAM, or the battery backed SRAM that is found in many computer systems for storing setup information. It is best if the key data points are stored in a memory that is persistent, in that it will be present even after power has been lost, and it is best if the memory is difficult to modify. It is difficult to modify a ROM, or an erasable/reprogrammable ROM such as Flash when it is part of the initialization of a system. Even though there are programs, often supplied by the manufacture of the system, that will reprogram the BIOS ROM, these program generally require a valid BIOS image from the supplier. Any partial modification of BIOS may render the system inoperable.

Continuing with step 330 of FIG. 3, the protected application and setup program are written to an installation media. This media may be any type of media that can be used to load programs. For example, it may be an optical (e.g., CDROM/CDRW/DVD) disk, floppy disk, removable flash device, ROM device, ZIP disk, etc. The media is then delivered to the customer for use, perhaps, if their system becomes corrupt or if they need to replace their primary hard disk. The media may be delivered with the system, mailed to the customer, or, in another embodiment, the customer may access the information through the internet, possibly from a different system, and create the installation media. The media may contain other files that may or may not be used or installed, such as an autoload.inf file. The media may also be bootable.

When the customer needs to load the application from the media, the customer inserts the media into the drive of the target system 350. If an autorun file such as autorun.inf is present on the media, the operating system may automatically start the setup system 360, possibly setup.exe. Alternately, the user may be required to start the setup system 360 manually. Once started, setup searches for the key data points in persistent storage 370. For example, setup may search for the keyword, “Gateway” at a few pre-determined locations in the BIOS ROM. At step 380, it is determined if a key data point has been found. If a key data point has not been found, step 385 displays an error message and the application is not unlocked and is not loaded. If a key data point is found, step 390 runs the install tool with the required password. At step 395 the install tool recognizes the correct password, unlocks the application and installs the content on the target system.

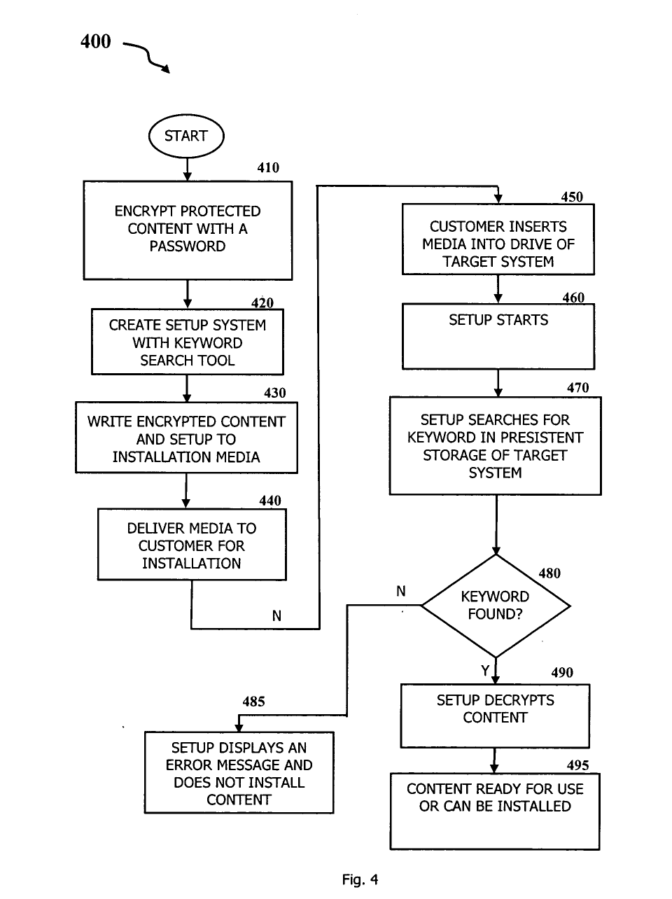

Referring to FIG. 4, a flow chart of the present invention for installing content, step 410 includes encrypting the content using a password. The content may be a set of programs such as Microsoft Office®, or any type of content that should be protected. In step 420, a setup system is created, perhaps a program called setup.exe which may be a 32 bit BIOS reading program written, perhaps, with Borland's Delphi-6. The setup system may be invoked by an auto-run initialization script, such as autorun.inf, that executes when the media is inserted into drive 150. The setup system has software that searches the system for key data points. The key data points may be a word or string such as “Gateway” stored at pre-determined locations within persistent memory, preferably in the initialization ROM. The initialization ROM may be any form of persistent memory such as EPROM, EEPROM, FLASH, FRAM, etc. and usually holds initialization software such as BIOS. In an alternate embodiment, there may be multiple key data points, whereas finding at least one key data point may be sufficient to identify a valid system. In other embodiments there may be multiple key data points and more than one may be required to identify a valid system. For example, the word “copyright” may be required to be at a first location and the word “Gateway” at a second location before the setup system permits installation. In another embodiment, one or more of the key data points may be located in what is known as, CMOS RAM, or the battery backed SRAM that is found in many computer systems for storing setup information. It is best if the key data points are stored in a memory that is persistent, in that it will be present even after power has been lost, and it is best if the memory is difficult to modify. It is difficult to modify a ROM, or an erasable/reprogrammable ROM such as Flash when it is part of the initialization of a system. Even though there are programs, often supplied by the manufacture of the system, that will reprogram a BIOS storage, these program generally require a valid BIOS image from the supplier. Any partial modification of BIOS may render the system inoperable.

Continuing with step 430 of FIG. 4, the encrypted content and setup program are written to an installation media. This media may be any type of media that can be used to load programs. For example, it may be an optical (e.g., CDROM/CDRW/DVD) disk, floppy disk, removable flash device, ROM device, ZIP disk, etc. The media is then delivered to the customer for use, perhaps, if their system becomes corrupt or if they need to replace their primary hard disk. The media may be delivered with the system, mailed to the customer, or, in another embodiment, the customer may access the information through the internet, possibly from a different system, and create the installation media. The media may contain other files that may or may not be used or installed, such as an autoload.inf file. The media may also be bootable.

When the customer needs to load the content from the media, the customer inserts the media into the drive of the target system at step 450. If an autorun file such as autorun.inf is present on the media, the operating system may automatically start the setup system 460, possibly setup.exe. Alternately, the user may be required to manually start the setup system 460. Once started, setup searches for the key data points in persistent storage, step 470. For example, setup may search for the keyword, “Gateway” at a few different locations in the BIOS ROM. At step 480, it is determined if a key data point has been found. If key data point has not been found, step 485 displays an error message and the application is not unlocked and is not loaded. If a key data point is found, step 490 runs and the content is decrypted using the same password as used to encrypt it. At step 495 the content is ready to be used or can be installed on the target system.

It is believed that the system and method of the present invention and many of its attendant advantages will be understood by the foregoing description. It is also believed that it will be apparent that various changes may be made in the form, construction and arrangement of the components thereof without departing from the scope and spirit of the invention or without sacrificing all of its material advantages. The form herein before described being merely exemplary and explanatory embodiment thereof. It is the intention of the following claims to encompass and include such changes.

1. A method of protecting content on a system comprising:
wrapping content in a protected installation tool, said protected installation tool being protected by a password;
searching by a setup program for least one key data point in at least one pre-determined location within a persistent memory of the system; and
upon finding said at least one key data point, providing by said setup program said password to enable installation of said content using said protected installation tool.

2. A method of protecting content of claim 1 wherein said step of searching for at least one key data point comprises searching Desktop Management Interface (DMI) tables for a specific value.

3. A method of protecting content of claim 1 wherein said step of searching for at least one key data point comprises comparing strings stored at pre-determined locations within said persistent memory to known strings.

4. A method of protecting content of claim 3 wherein said persistent memory is at least one type of memory chosen from a group consisting of ROM, PROM, EPROM, EEPROM, Flash, one-time programmable memory, battery-backed SRAM and FRAM.

5. A method of protecting content of claim 4 wherein said content is an application.

6. A method of protecting content of claim 5 wherein said application is a Microsoft Office Suite.

7. A method of protecting content on a system comprising:
encrypting a content using a password;
searching by a setup program at least one for key data point in at least one pre-determined location within a persistent memory of the system; and
upon finding said at least one key data point, decrypting by said setup program said content using said password.

8. A method of protecting content of claim 7 wherein said step of searching for at least one key data point comprises searching Desktop Management Interface (DMI) tables for a specific value.

9. A method of protecting content of claim 7 wherein said step of searching for at least one key data point comprises comparing strings stored at pre-determined locations within said persistent memory to known strings.

10. A method of protecting content of claim 9 wherein said persistent memory is at least one type of memory chosen from a group consisting of ROM, PROM, EPROM, EEPROM, Flash, one-time programmable memory, battery-backed SRAM and FRAM.

11. A method of protecting content of claim 10 wherein said content is an application.

12. A method of protecting content of claim 11 wherein said application is a Microsoft Office Suite.

13. A method of protecting content of claim 11 further comprising the step of:
installing said application.

14. An apparatus for installing protected content comprising:
a processor;
a persistent memory coupled to said processor, said persistent memory including initialization software, said persistent memory also including at least one key data point;
a drive coupled to said processor for loading programs, said drive configured to accept a removable media; and
a recovery media, said recovery media configured to be read by said drive;
wherein said recovery media includes at least a setup program and a content, said content encrypted with a predetermined password;
wherein said setup program is configured to search said persistent memory for said at least one key data point and if said at least one key data point is found, said setup program is configured to decrypt said content by use of said predetermined password.

15. An apparatus for installing protected content according to claim 14 wherein said at least one key data points is located in a Desktop Management Interface (DMI) table.

16. An apparatus for installing protected content according to claim 14 wherein said persistent memory is at least one type of memory chosen from a group consisting of ROM, PROM, EPROM, EEPROM, Flash, one-time programmable memory, battery-backed SRAM and FRAM.

17. An apparatus for installing protected content according to claim 14 wherein said content is an application.

18. An apparatus for installing protected content according to claim 17 wherein said application is a Microsoft Office Suite.

19. An apparatus for installing protected content comprising:
a processor;
a persistent memory coupled to said processor, said persistent memory including initialization software, said persistent memory also including at least one key data point;
a drive coupled to said processor for loading programs, said drive configured to accept a removable media; and
a recovery media, said recovery media configured to be read by said drive;
wherein said recovery media includes at least a setup program and a content, said content encoded in an installation tool, said installation tool configured to require a predetermined password to decode said content;
wherein said setup program is configured to search said persistent memory for said at least one key data point and if said at least one key data point is found, said setup program is configured to initiate said installation tool and provide said password to complete installation of said content.

20. An apparatus for installing protected content according to claim 19 wherein said at least one key data points is located in a DMI table.

21. An apparatus for installing protected content according to claim 19 wherein said persistent memory is at least one type of memory chosen from a group consisting of ROM, PROM, EPROM, EEPROM, Flash, one-time programmable memory, battery-backed SRAM and FRAM.

22. An apparatus for installing protected content according to claim 19 wherein said content is an application.

23. An apparatus for installing protected content according to claim 22 wherein said application is a Microsoft Office Suite.
